(19) United States
(12) Patent Application Publication
(10) Pub. No.: US 2025/0198023 A1
(43) Pub. Date: Jun. 19, 2025

(54) ELECTRODE BUBBLE REMOVAL

(71) Applicant: Worcester Polytechnic Institute, Worcester, MA (US)

(72) Inventor: Mehdi Mortazavi, Wilbraham, MA (US)

(21) Appl. No.: 18/985,714

(22) Filed: Dec. 18, 2024

Related U.S. Application Data
(60) Provisional application No. 63/611,434, filed on Dec. 18, 2023.

(51) Int. Cl. C25B 9/30; C25B 1/04; C25B 15/02

(52) U.S. Cl. CPC C25B 9/30; C25B 1/04; C25B 15/02

(57) ABSTRACT

An electrolyzer for gaseous production such as hydrogen gas includes an oscillating electrode driven at a natural frequency of the gaseous bubbles improves output by readily removing the gaseous bubble product from the electrode surface, thereby exposing greater electrode surface area for subsequent electrolysis reactions. A natural frequency of the gaseous product determines an oscillation frequency with which to drive the electrode accumulating the gaseous product, such as hydrogen bubbles, to agitate and release the bubbles which then rise to the surface of the liquid filled containment. Integrating oscillation logic for agitating the otherwise stationary electrode or cathode in a PEM water electrolyzer improves hydrogen production by readily evacuating the generated hydrogen to free up the electrode area for additional electrolysis reactions.

### RELATED APPLICATIONS

This patent application claims the benefit under 35 U.S.C. § 119 (e) of U.S. Provisional Patent App. No. 63/611,434, filed Dec. 18, 2023, entitled “ELECTRODE BUBBLE REMOVAL,” incorporated herein by reference in entirety.

### BACKGROUND

Hydrogen based technology has great potential to replace or supplement fossil fuels for energy sources due to its generally high reactivity and predictable chemistry, however its ability to readily combine with many substances also presents cautionary barriers for its handling. Hydrogen is one of the most efficient energy carriers, and can be obtained from different sources of raw materials including water. Among many hydrogen production methods, eco-friendly and high purity hydrogen can be obtained by water electrolysis. PEM (Proton Exchange Membrane) water electrolysis can be considered rather a promising technology for high pure efficient hydrogen production from renewable energy sources with sustainability and environmental benefits as it emits only oxygen as byproduct without any carbon emissions.

### SUMMARY

An electrolyzer for gaseous production such as hydrogen gas includes an oscillating electrode driven at a natural frequency of the generated gaseous bubbles improves output by readily removing the gaseous bubble product from the electrode surface, thereby exposing greater electrode surface area for subsequent electrolysis reactions. A natural frequency of the gaseous product determines an oscillation frequency with which to drive the electrode accumulating the gaseous product, such as hydrogen bubbles, to agitate and release the bubbles which then rise to the surface of the liquid filled containment. Integrating oscillation logic for agitating the otherwise stationary electrode or cathode in a PEM water electrolyzer improves hydrogen production by readily evacuating the generated hydrogen to free up the electrode area for additional electrolysis reactions.

Configurations herein are based, in part, on the observation that hydrogen production, through the use of fuel cells and electrolyzers, shows potential for widescale grid supplementation by storing electrical energy in a hydrogen form and releasing it back as electricity during diminished production of periodic sources such as solar and wind. Unfortunately, conventional approaches to hydrolysis and fuel cell usage suffer from the shortcoming that large amounts of electricity are required for an appropriate scale, and substantial physical area is needed to provide an adequate facility housing. Accordingly, configurations herein substantially overcome the shortcomings of conventional electrolysis by providing an electrolyzer for driving an electrolysis electrode at a natural frequency of the generated gaseous bubbles for improving efficiency and maximizing use of available electrode area for electrolysis reactions.

The hydrogen production market through water electrolysis is rapidly growing. In this process, gas bubbles form and accumulate on the electrode surfaces. This accumulation reduces the efficiency of electrolyzers by limiting contact between liquid water and electrodes. Enhancing the departure of bubbles from the electrode surfaces can significantly boost electrolyzer efficiency. The disclosed approach achieves improved efficiency in the electrolysis process by oscillating electrodes at frequencies at or near the natural frequency of bubbles.

In further detail, A PEM (Proton Exchange Membrane) water electrolyzer includes an electrode responsive to a water electrolysis process. An electrolyzer containment is configured for housing a water electrolysis process, where the electrode is immersed in the containment for the water electrolysis process. An electrolysis driver delivers an electrical current to the electrolyzer, and an oscillator is integrated in the electrolyzer for oscillating the electrode.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a schematic illustration of the electrolyzer described herein;

FIG. 2 is a diagram of the electrolyzer of FIG. 1 employed in a PEM water electrolyzer; and

FIG. 3 shows alternate construction of the PEM water electrolyzer (WE) of FIG. 2.

### DETAILED DESCRIPTION

Configurations herein depict an electrolysis system including a device and method applicable for improving electrolysis and other electrochemical gaseous production by driving an electrode at a natural frequency corresponding to bubbles of the produced gaseous product.

Technological development of energy development, particularly for electrical utility generation often referred to as the “Grid,” has focused on producing hydrogen through renewable energy sources that are respectful of ecosystems. One of the most promising methods is electrolysis. This well known phenomenon has been represented by the following equation:

2H₂O⇄2H₂+O₂

It can be readily ascertained that an abundant supply of the constituent elements favors the use of the electrolysis process in conjunction with different renewable energy sources, such as solar energy and wind energy, which can result in the production of clean and renewable high purity (99.99%) hydrogen (green hydrogen) and oxygen gases.

In chemistry and manufacturing, electrolysis is a technique that uses direct electric current to drive an otherwise non-spontaneous chemical reaction. Electrolysis is commercially significant as a stage in the separation of elements from naturally occurring sources such as ores using an electrolytic cell.

An electrolyzer is a device that uses electricity to split water or other components into their constituent elements through electrolysis. Electrolysis is a chemical reaction where an electric current passes through a substance, causing it to decompose into its basic components.

In the case of water electrolysis, an electrolyzer uses an electric current to split water molecules into hydrogen and oxygen gases. The hydrogen gas can be stored as either compressed gas or liquefied. The oxygen created is released back into the air or captured and stored to supply to other industrial processes.

Electrolysis of water is therefore a capable method for production of hydrogen because it uses renewable H₂O and produces only pure oxygen as a by-product. Additionally, an electrolysis process may utilizes the DC power from sustainable energy resources for example solar, wind and biomass. Nonetheless, water electrolysis encounters barriers such as a need for high cell efficiency and greater hydrogen production rate with high purity needed to facilitate widespread conversion to electrical energy using low temperature fuel cells.

PEM electrolysis in the disclosed electrolyzer may operate in conjunction with a fuel cell. Fuel cells are electrochemical cells that convert chemical energy into electricity and electrolyzers convert electrical energy into molecules with high potential energy densities. Together they form complementary technologies where a PEM water electrolyzer uses electricity to split water into hydrogen and oxygen, while a PEM fuel cell uses hydrogen and oxygen to generate electricity.

While conventional approaches focus on passive methods of removing water from the flow channels of the PEM fuel cell, few studies investigated on the active methods. In this context, the passive water removal methods refer to water removal from the flow channels of the fuel cell through capillary wicking to corners of the flow channel, shear stresses and pressure differences generated by reactant flow, and/or liquid water evaporation by the gas stream. In contrast to passive methods of water removal, the active water removal schemes refer to methods that facilitate water removal by an external excitation. Acoustic pressure waves superimposed on a reactant channel air flow can be an effective means to enhance liquid water removal from gas diffusion layer surfaces. While these conventional approaches focus on manipulation of liquid droplets in the fuel cell, the disclosed approach is directed to hydrogen gas bubble agitation and removal in a PEM water electrolyzer.

Electrolyzers are therefore a complementary technology to fuel cells. Operating much like a battery, fuel cells produce electricity and heat. Unlike a battery, a fuel cell can produce endless electricity if a fuel—like hydrogen—is continuously supplied. Fuel cells that use hydrogen generate electricity that is zero emissions at the point of use for its applications, meaning fossil fuels are not needed, and no harmful emissions are created.

In the conventional approaches described above, referring to water droplets in a fuel cell, the “natural frequency of a fluid” refers to the frequency at which a fluid system naturally oscillates when disturbed, essentially the rate at which it would vibrate back and forth if left to its own devices, and is primarily determined by the fluid's density, container geometry, and any external forces acting on it; it's often calculated using fluid dynamics equations and can be influenced by factors like the fluid's filling level within the container. Such a natural frequency based on a resonant oscillation can be determined for various fluids used in the disclosed approach.

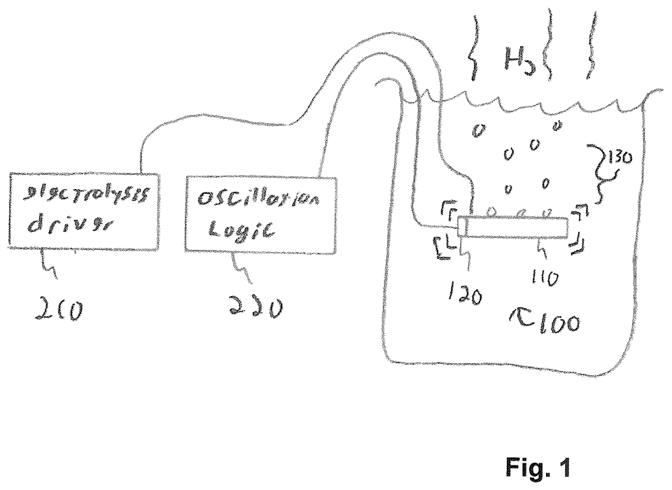

FIG. 1 is a schematic illustration of the electrolyzer described herein. Referring to FIG. 1, efficient removal of bubbles generated during water electrolysis in hydrogen production can be provided by exciting them at their natural frequency through oscillating the electrolyzer or electrode/cathode therein.

To achieve this goal of bubble excitation and removal as in FIG. 1, the system's oscillation can be utilized to externally excite bubbles at their natural frequencies. This may involve vibrating the electrode with a mechanical oscillator, incorporating a mechanism in the electrolyzer to induce oscillation, generating oscillation in the fluid flow within the electrolyzer, and employing other methods that eventually induce bubble oscillation. An electrolyzer device 100 includes an electrode 110 adapted for immersion for electrolysis, and an electrolysis driver 210 for delivering an electrical current to the electrolyzer. An oscillator 120 is integrated in the electrolyzer for oscillating the electrolyzer 100. Oscillation logic 220 drives the oscillator 120 at an oscillation rate based on a natural frequency of bubbles 130 on the electrolyzer. The electrolyzer 100 therefore includes the oscillator 120 and the electrode 110 agitated or vibrated by the oscillator The electrode 110, usually a cathode, is powered by the electrolysis driver 210 for causing an electrolysis reaction, such that the electrolysis reaction forms hydrogen bubbles on the electrode surface.

Upon immersion in water, the oscillation logic 220 drives the electrolyzer 100 at an optimal frequency for freeing (ejecting) bubbles from the electrode surface, freeing up additional electrode area for electrolysis production. An optimal oscillation frequency allows electrolysis at a low power demand due to maximal bubble removal, which is based on the natural frequency of the bubbles, which varies according to bubble size.

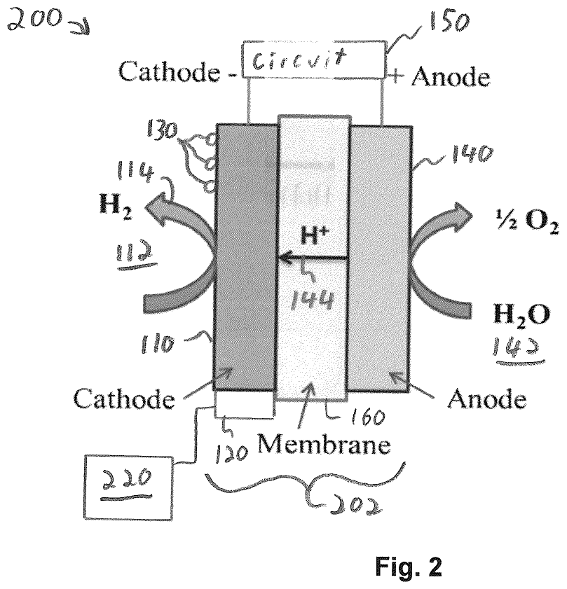

FIG. 2 is a diagram of the electrolyzer of FIG. 1 employed in an example PEM water electrolyzer. PEM water electrolysis technology is similar to the PEM fuel cell technology, where gas diffusion membranes such as solid polysulfonated membranes (Nafion® or Fumapem®) may be used as an electrolyte, or proton conductor. These proton exchange membranes having many advantages such as lower gas permeability, high proton conductivity (0.1±0.02 S cm-1), lower thickness (20-300 μm) and high-pressure operations. In terms of sustainability and environmental impact, PEM water electrolysis is one of the favorable methods for conversion of renewable energy to high pure hydrogen. Another promising aspect of PEM water electrolysis has great advantages such as compact design, high current density (above 2 A cm-2), high efficiency, fast response, small footprint, and operates under low temperatures (20-80° C.).

Referring to FIGS. 1 and 2, In a PEM water electrolysis containment 200, water is electrochemically split into hydrogen and oxygen at their respective electrodes such as hydrogen at the cathode 110 and oxygen at the anode 140. PEM water electrolysis is accrued by pumping of water 142 to the anode where it is spilt into oxygen (O₂), protons (H⁺) 144 and electrons (e). These protons are traveled via a proton conducting membrane 160 to the cathode side 112. The electrons exit from the anode through an external power circuit 150, which provides the driving force (cell voltage) for the reaction. At the cathode side, shown as electrode 110, the protons and electrons re-combine to produce the hydrogen 114, according to the following equations:
Anode: H₂O→2H⁺+½O₂+2e⁻
Cathode: 2H⁺+2e⁻→H₂
Overall cell: 2H₂O→H₂+½O₂

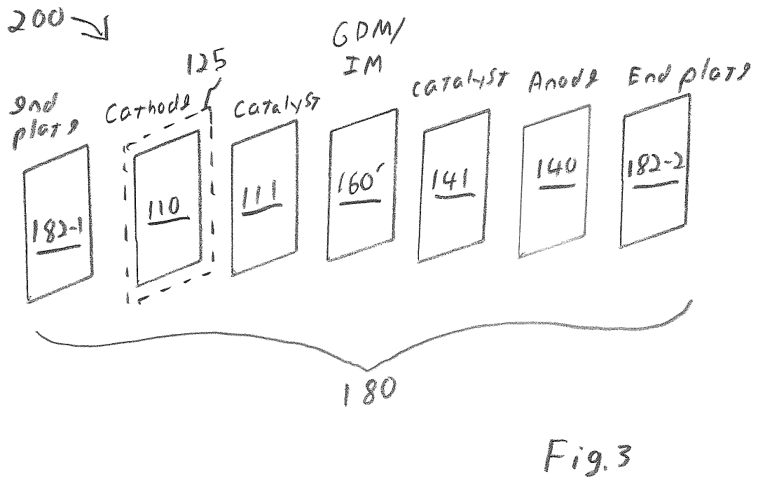

FIG. 2 outlines the general components, however additional membranes, catalysts, and chemical reactions may also be incorporated, discussed further in FIG. 3 below. In the approach of FIG. 2, a PEM (Proton Exchange Membrane) water electrolyzer containment 200 includes at least one electrode such as the cathode 110 responsive to a water electrolysis process 202. The electrolyzer containment 200 is configured for the water electrolysis process 202, where the cathode 110 is immersed in the containment 200 and responsive to the water electrolysis process 202. An electrolysis driver circuit 150 delivers an electrical current/voltage to the electrolyzer containment 200, and the oscillator 120 is integrated in the electrolyzer 200 for oscillating the electrode 110.

While the electrode 110 is shown as a cathode in the water electrolysis process 202, the operative function is an electron for combining with the hydrogen ions 144 (protons) transported across the membrane 160 for generating hydrogen 114 that initially forms as bubbles 130.

The oscillator 120 is engaged with the cathode 110 for agitating the cathode to facilitate release of the gaseous bubbles 130 formed from hydrogen ions 144. Any suitable mechanical coupling or attachment may be provided, such as agitating only the cathode 110, the stack formed by the cathode 110, membrane 160 and anode 140, or the entire electrolysis containment 200, for example. The membrane 160 is generally a proton exchange membrane configured for passing protons 144 to the cathode. 110.

The oscillator 120 is driven by the oscillating logic 220 which is configured to drive the electrode at a natural frequency of the bubbles 130 resulting from the water electrolysis process. In the disclosed approach, the bubbles 130 are hydrogen bubbles, however any suitable gaseous product resulting from the electron transfer may benefit from the bubble-liberating oscillations.

FIG. 3 shows alternate construction of the PEM water electrolyzer (WE) of FIG. 2. The PEM electrolysis of FIG. 2 typically involves the use of a proton exchange membrane (PEM) made from a special polymer. This PEM separates the anode and cathode electrically. At the start of the process, liquid, ultrapure water may be supplied to the anode side of the electrolyzer containment 200.

In operation, the electrolysis process 202 occurs in a stack 180 defined at least by the cathode 120, membrane 160 and anode 140. In practice, other components such as anode and cathode catalyst layers 141, 111 may be employed, as well as endplates 182-1 . . . 182-2 (182 generally) to form a seal around the containment 200. Catalysts may also be impregnated, coated or distributed throughout the electrodes, rather then forming a discrete layer. The oscillator 120 engages or attaches to the cathode 110 by a surrounding frame 125, engagement with the full stack 180 or containment 200, or similar attachment for mechanical coupling. The membrane 160, while shown as a proton exchange membrane, is more generally an ion exchange membrane 160′ suitable for selective passage of ions, molecules or compounds for facilitating the formation of the gaseous bubbles 130, optionally complemented by the catalyst 111, 141 layers. Other electrolyzers in addition to PEM electrolyzers may be employed within the electrolyzer assembly, such as alkaline water electrolysis (AWE), solid oxide electrolysis (SOE) and microbial electrolysis, in alternate configurations.

The major PEM water electrolysis cell components are membrane electrode assemblies (MEAs), current collectors (gas diffusion layers), and separator plates. An overview of a typical PEM water electrolysis cell assembly was shown above in FIG. 2, however, the heart of the electrolysis cell is the MEA for electrolysis 202 which is separated the cell in to two half cells (anode and cathode).

The full cell containment 200 therefore includes at least an ionic exchange membrane 160′ in communication with the electrode for receiving ions for hydrogen electrolysis, thus forming the PEM stack 180 including the cathode 110, anode 140, and an ion exchange membrane 160′ disposed between the cathode and anode. A voltage source or circuit 150 is also included for providing electrons for driving the electrolysis reaction 202.

In various prototypes and deployment apparatuses, the membrane electrode assemblies are comprised of a membrane 160′, ionomer solution and anode, and cathode electrocatalysts which are responsible for a substantial portion of overall cell cost. As the membrane 160′ is central to the PEM-WE cell operation, the most commonly used membranes are Perfluorosulfonic acid polymer membranes such as Nafion®, Fumapem®, Flemion®, and Aciplex®. These membranes have unique properties such as high strength, high efficiency and high oxidative stability, dimensionally stabile with change of temperatures, good durability and high proton conductivity. However, currently Nafion membranes are mostly used in PEM water electrolysers because Nafion membranes have tough advantages such as operating at higher current densities (2 A/cm2), high durability, high proton conductivity and good mechanical stability. Typically, the membrane electrode assemblies are fabricated by different methods, but many rely on a catalyst coated on membrane (CCM) method.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An electrolyzer device, comprising:
an electrolyzer having an electrode adapted for immersion for electrolysis;
an electrolysis driver for delivering an electrical current to the electrolyzer; and
an oscillator integrated in the electrolyzer for oscillating the electrode.

2. The device of claim 1 further comprising oscillation logic for driving the oscillator at an oscillation rate based on a natural frequency of bubbles on the electrolyzer.

3. The device of claim 2 wherein the electrolyzer includes the oscillator and an electrode, the electrode for causing an electrolysis reaction, the electrolysis reaction forming bubbles on the electrode surface.

4. A PEM (Proton Exchange Membrane) water electrolyzer, comprising:
an electrode responsive to a water electrolysis process;
an electrolyzer containment configured for a water electrolysis process, the electrode immersed in the containment for the water electrolysis process;
an electrolysis driver for delivering an electrical current to the electrolyzer; and
an oscillator integrated in the electrolyzer and responsive to oscillation logic for oscillating the electrode.

5. The device of claim 4 wherein the electrode is a cathode in a water electrolysis process.

6. The device of claim 5 further comprising an ion exchange membrane in communication with the electrode for receiving ions for hydrogen electrolysis.

7. The device of claim 5 further comprising:
a PEM stack including the cathode, an anode, and an ion exchange membrane disposed between the cathode and anode; and
a voltage source for providing electrons for electrolysis.

8. The device of claim 4 wherein the oscillator is engaged with the cathode for agitating the cathode to facilitate release of gaseous bubbles formed from hydrogen ions.

9. The device of claim 6 wherein the ion exchange membrane is a proton exchange membrane configured for passing protons to the cathode.

10. The device of claim 4 wherein the oscillator is configured to drive the electrode at a natural frequency of bubbles resulting from the water electrolysis process.

11. The device of claim 10 wherein the bubbles are hydrogen bubbles.

12. A method for hydrogen production, comprising:
disposing an electrode in a containment responsive to a water electrolysis process;
filling the containment with water for a water electrolysis process, the electrode immersed in the containment;
engaging an oscillator integrated in the electrolyzer for oscillating the electrode; and
energizing an electrolysis driver for delivering an electrical current to the oscillator.

13. The method of claim 12 further comprising engaging an ion exchange membrane in communication with the electrode for receiving ions for hydrogen electrolysis.

14. The method of claim 13 wherein the electrolyzer is a PEM (Proton Exchange Membrane) water electrolyzer, wherein the oscillator is engaged with the cathode for agitating the cathode to facilitate release of gaseous bubbles formed from hydrogen ions.
